(19) United States
(12) Patent Application Publication
(10) Pub. No.: US 2005/0286265 A1
(43) Pub. Date: Dec. 29, 2005

(54) Linear LED housing configuration

(75) Inventors: Thomas Lawrence Zampini, Morris, CT (US); Thomas Lawrence Zampini II, Morris, CT (US); Mark Alphonse Zampini, Morris, CT (US)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: INTEGRATED ILLUMINATION SYSTEMS, INC., Morris, CT (US)

(21) Appl. No.: 11/121,022

(22) Filed: May 4, 2005

Related U.S. Application Data
(60) Provisional application No. 60/567,456, filed on May 4, 2004.

(51) Int. Cl. F21V 7/04

(52) U.S. Cl. 362/612; 362/800

(57) ABSTRACT

The present invention relates to lighting fixtures using light emitting diodes (LEDs) as a light source. More specifically, the present invention relates to a linear configuration of a single or multiple LEDs being used in a housing/fixture, including those used in architectural, automation, medical, marine, military, industrial, and transportation applications.

### RELATED APPLICATION

The present invention claims priority from Provisional Application No. 60/567,456 filed May 4, 2004, entitled “BUNK LIGHT”, the disclosure of which is hereby incorporated by reference herein in its entirety. The present invention is also related to patent application Ser. No. 10/920,347, entitled “COLLIMATING AND CONTROLLING LIGHT PRODUCED BY LIGHT EMITTING DIODES” filed May 18, 2004, (hereinafter the '347 application) the disclosure of which is hereby incorporated by reference in its entirety into the instant application.

### FIELD OF THE INVENTION

The present invention relates to lighting fixtures using light emitting diodes (LEDs) as a light source. More specifically, the present invention relates to a linear configuration of a single or multiple LEDs being used in a housing/fixture, including those used in architectural, automation, medical, marine, military, industrial, and transportation applications.

### BACKGROUND OF THE INVENTION

Today, a large amount of general, task, and accent lighting is accomplished through the use of a linear fluorescent light bulbs installed into a housing. The fluorescent bulbs are used as a means of illumination. Due to the linear design of the fluorescent light bulb, most of these housings or fixtures are of linear configuration and range from simplistic design, to housings designed for any environment including environments where explosion proof and waterproof housings are required. While the florescent light bulb is efficient, it has multiple areas that are improved through the use of an LED configuration.

A fluorescent light has a very limited lifetime; typically up to 10,000 hours or so. This requires a maintenance staff or team simply dedicated to changing light bulbs on a large fluorescent installation such as those found in a large building or a Navy vessel which leads to added expenses over the life of the product. In many applications, the fluorescent bulbs are difficult to replace due to the fact that they are inaccessible. For example, many fluorescent bulbs are used for cove lighting whereas the fluorescent bulb is shielded by a ledge or horizontal recess close to the ceiling and upper wall in an architectural application. Changing these bulbs requires the use of heavy equipment to raise the operator to such heights where the bulbs may be safely and easily replaced. Another example includes shipboard lighting, whereas almost all shipboard lighting fixtures are enclosed in such a way that accessing the fluorescent bulbs includes removing fasteners on the fixture. In almost all waterproof fixtures, a gasket is used on bulb access areas for maintaining the integrity of the fixture and not allowing water to flow into the fixture. As the fluorescent bulbs offer a short life when compared to an LED system, it is inevitable that a maintenance crew will be required to open the fixtures and risk damaging the gaskets every time they do so. Should this happen, water may enter the fixture and destroy not only the fluorescent bulb, but also the other components located within the fixture. Therefore, a light source that is replaceable, however offers a much longer lifetime than that of the fluorescent is needed.

While fluorescent bulbs are efficient, they are not a directional light source, rather they generate light in all directions. Therefore, while the source is highly efficient (approx. 65 lumens/watt), due to the fact that much light is wasted, the fixture efficiency is not very high. Fluorescent sources also do not offer the ability to direct light where required, such as to emphasize an object or area where enhanced illumination would do justice to the application. When reflectors are built into the fluorescent fixtures to direct light, the reflectors cause the fixtures to increase in size which is not desirable in most applications. Therefore, there is a need for a light source that will be a directional, small, and efficient.

From an environmental perspective, fluorescent lights contain chemicals such as mercury and therefore cannot be simply discarded. For example, it is believed to cost the U.S. Navy over one dollar to dispose of each used fluorescent bulb on a ship. Furthermore, it is known that a US Navy destroyer will be required to store on board over ten thousand extra fluorescent light bulbs before any trip, which results in added weight and wasted space.

Therefore, a need exists for a long lasting, directional, small, efficient, and environmental friendly light fixture.

### SUMMARY OF THE INVENTION

A light source has been developed called the V-Line. The V-Line is a linear LED based system described in the '347 application.

A key point of the invention described in the '347 application is that linear optical technology has been incorporated that is lit by a single or multiple LEDs spaced along the length of the optic. Single or multiple optics may be used to achieve a linear beam of light, similar to that of fluorescent lighting. This linear optic may be as simple as a half round of acrylic as described in the '347 application.

The linear optic system of the '347 application incorporates all of the benefits of an LED light source while simultaneously providing similar light output, efficiency, and distribution to that of the fluorescent fixture. However unlike the fluorescent fixture, the linear optic system offers an operating life of up to 100,000 hours, contains no hazardous materials, and is a directional source, meaning that it is available in a linear format with a defined emitting angle, i.e. 30, 45, or 60 degrees.

The present invention is a housing that is used for illumination and utilizes the linear optic system as a light source. While the linear optic system works well for a variety of applications, there are many applications where a standalone linear optic system does not lend itself well including applications where the light fixture is subjected to environmental considerations including: UV, heat, water, ice, shock, and vibration. The linear optic system also does not lend itself well in applications where the physical characteristics of the light fixture are to be decorative as well as functional.

The present invention can be used for a variety of applications including those where fluorescent fixtures are traditionally used. The actual size of the housing is customizable per application, in some cases the housing being over eight (8) feet long, in other cases, the housing being only several inches long. In both cases, the housing utilizes the linear optic system as a light source which is customized in length and configuration to fit the housing. The material of the housing may be plastic or metal, metal including that of stainless steel, aluminum, brass, bronze, copper etc. Generally, housings will be extruded due to the linear configuration of the linear optic system, however housings may also be machined, molded, stamped, or cast. Due to its low profile, the linear optic system allows the housing size to be very low profile, however simultaneously, for applications where a larger housing is required; there is no limitation to the physical size of the fixture. Housings may be decorative or plain, depending on the application. For an application where present invention is used for general illumination in a hotel lobby, the housing may be decorative, including fancy or contemporary lines, engravings, and features to be added to the housing. In the case that the present invention is used as a flush mounted illumination panel on a US Navy flight deck, such as those used as line up lights for incoming helicopters, the housing will be manufactured for high impact, high vibration, and demanding weather conditions. In this case, a smooth surface is preferred in order to reduce the radar cross section of the vessel. Therefore it should be noted that the actual housing used in the present invention is designed to accommodate one or more linear optic system configurations and is completely customizable in, material, style, size, thickness, etc.

While the housing may be used only for decorative or functional purpose and may not require a protective window, depending on the application, the housing may in fact require this level of protection. The protective window can be simply designed to keep dust out of the housing, or it can be more robustly designed to keep out water, chemicals, and provide a surface designed for high impact. The material of the window can be that of glass, tempered glass, polycarbonate, acrylic, or any other clear material as required by the application. The material may be of any thickness depending on the application. The window may be installed by traditional methods, including those of using a gasket and fasteners. The window may also be installed such that it is adhered permanently to the housing. This is possible due to the long life of the linear optic system source. Adhesives may include UV activated adhesives. The window material may also range in light emitting characteristics. For example, the window may be frosted to provide a glowing surface, it may be optically clear and optically coated to allow light to pass through with minimum loss, it may be colored such that it will filter the light emitting from the linear optic system (i.e. a blue coloring on the window will only allow blue light to pass through), it may be coated with antiglare materials to reduce glare coming off of the fixture, etc. For additional effect and control, between the window and the linear optic system, filters and diffusers may be incorporated into the housing. Diffusers include holographic diffusers that are designed to change the emitting angle of the linear optic system. Color Filters include those used conventionally such as those manufactured by Rosco International (www.rosco.com). Filters may be used not only for effect, but for color correction. While white LED technology has steadily progressed, most available white LEDs are available between 5500 and 10,000 Kelvin, which ranges from a very white light (5500 K) to a bluish white light (10,000 K). While this is acceptable for many applications, many architectural applications will require a warmer white, such at 2,800 Kelvin, which is that of a traditional incandescent bulb. For example, while the linear optic system may have a color temperature of 6000 Kelvin, by inserting the proper color filter between the linear optic system and the window, the color temperature emitted from the housing will be that of 2,800 Kelvin. The color filters (gels) may be installed mechanically such as that of a bracket, or installed by a tape or adhesive to the window, housing, or linear optic system. The diffusers and filters may be installed at the factory or sold to the end user for installation in the field, thus offering greater flexibility to the installer. It also should be noted that should a color that is available in an LED package be specified for a program such as the color Red, then no filter will be required as the LED source is a monochromatic source and will not require a filter to generate the red color. In addition, should the present invention be required to produce multiple colors of light from a single fixture, there are two ways to do so. The first way is to use two different color LEDs in a single linear optic system or multiple linear optic systems, such as white and red or any other combination of colors and switch back and forth depending on what effect is desired. This offers advantages never before possible with fluorescent lighting as the fluorescent fixture would need to accommodate two fluorescent bulbs, one that is white and one that is white with a red filter or a colored fluorescent, resulting in a much larger fixture size. The second way is to use color mixing. By installing into the linear optic system or into multiple linear optic systems three LED colors, red, green, and blue, the present invention will be capable of generating millions of different colors and effects by creating combinations of the three colors.

While linear optic system utilizes its own optical configuration, reflective surfaces and reflectors may be used internal and or external to the housing to offer additional control of the light emitted.

The linear optic system can be installed to the housing a number of ways depending on the application and the function. The linear optic system can be installed via an adhesive, including thermally conductive adhesive, by fasteners, by press fit or other type of mechanical fit. Depending on the application, the linear optic system may be installed with either permanent or adjustable mounting. For applications where the light fixture is intended for a single purpose, such as a Navy Bunk Light, the housing may be designed and the linear optic system positioned at the factory such that the present invention provides the proper light distribution and effect. For generic usage, the housing may be designed such that the linear optic system is installed on an assembly that is capable of pivoting, thus allowing the installer to move the linear optic system within the fixture in order to achieve the proper effect. The pivoting may occur via a friction fit, by pivoting the linear optic system and tightening down on a fastener in order to lock the pivot in place or by any other means that a pivot may be accomplished. The linear optic system may also be positioned such that the distance between the linear optic system and the window or top of the housing may be adjusted in order to allow flexibility to the design. Generic usage is critical for applications such as architectural lighting where as a lighting specifier will use the same light fixture for multiple applications, thus requiring flexibility in order to achieve the proper effect. Recognize that the multiple linear optic systems may be used within a single housing and that they may pivot independently. For example, if the present invention is used for illuminating the exterior wall of a building that includes a window, the two linear optic systems may be installed into the housing. The first linear optic system will be directed below the window. The second linear optic system will be directed above the window. Therefore, there is a wash on the building wall while there is no glare on the building window. It should be noted that the unlike any other linear light fixture, the present invention is capable of millions of light distribution patterns and emitting angles due to the fact that the linear optic system may be adjusted within the fixture to produce any effect required for an application. Typically light fixtures are purchased with a specific emitting angle. The present invention may be purchased as a generic system that is capable of many emitting angle configurations. While providing environmental protection to the linear optic system, the housing also functions as a heat sink for the linear optic system allowing the linear optic system to take advantage of the extra surface area provided by the housing. In some cases, it is required that when the linear optic system is installed, it should be installed with a thermal grease, thermal tape, or thermal epoxy. Fans may also be installed within the housing in order to provide air circulation within the fixture to minimize thermal hot spots or to replace the air in the housing depending on the configuration.

As a fluorescent fixture has a ballast to power the bulb, LED systems require a constant current source, whether it is a power resistor or a semiconductor based design such as an I2S SmartDriver (high efficiency switching regulator) disclosed in the '347 application. This constant current source, many times referred to as a driver may be located in one of three places. The first location as described in the '347 application is within the linear optic system. In this configuration disclosed the '347 application, wires or a multi-conductor cable will enter the housing of the present invention and wire to the one or more linear optic system assemblies located within the housing. Wires may enter through a strain relief that may be waterproof. Electrical connection my also be made via an electrical connector located on the housing which is wired to the linear optic system. The connectors may be positioned and designed such that either a cable assembly will mate with the connector on the housing, or one housing may plug into another housing, thus eliminating wiring between fixtures for applications where more than one fixture is utilized. The second location that the driver may be located is within the housing, where as one or multiple drivers and associated wiring and controls will be mounted within the housing and electrically connected same as above. The third location that the driver may be located is external to the housing and wired to one or more of the present inventions same as above. For all three configurations, the input voltage may vary from application to application, some being that of line voltage (i.e. 120, 220, 277 VAC) and some being of low voltage (i.e. 12, 24 VAC). In some cases, a power supply or transformer may be installed to the housing and wired in line between the incoming voltage and the driver to step down/boost and clean up the input voltage.

The driver systems also are capable of 0 to 100% dimming which never before has been possible in a fluorescent system. The dimming may be controlled either locally at the present invention or remotely. In most cases of dimming, an additional control board or control assembly will be installed within the housing or the linear optic system.

The present invention may be controlled locally by means of controls installed within the housing, mounted to the housing, or external to the housing. Controls include those of switches, potentiometers, touch screens, membrane switches, or any other means of user interface.

In the case where dimming is controlled locally at the present invention, this is typically for applications where the present invention will be installed, the light level of the linear optic system will be set at the fixture for the optimal level for the application, and the intensity of the linear optic system will most likely not be adjusted in the future. The electronics for doing so will be installed within the housing. The linear optic system intensity may be adjusted by but not limited to a potentiometer or by a hand held programming device that connects to the electronics within the housing. It is also a known fact that for any light source including LEDs, that over time the source will decrease in light output, which is called lumen maintenance. Therefore, a solution to avoid lower light levels over time is to set the present invention's intensity at the preferred level once installed and then through the use of a controller located within the housing or within the linear optic system, program the fixture such that over time the driver's output current will slowly increase to make up for the reduced efficiency of the LEDs.

In the case where the dimming is controlled externally to the present invention, there are several ways to do so. The first way is by connecting to the present invention a standard 0 to 10 Vdc control voltage. The 0 to 10 Vdc control voltage is typically used in architectural applications whereas the control voltage is used as a reference voltage. The second way to control the intensity is by connecting to the present invention an analog pwm signal that is used to provide a reference. This method is preferred to the 0 to 10 Vdc control voltage as it can be used over much longer distances. In both cases, if multiple linear housings are connected to the same control voltage or analog pwm signal, each will respond identically, thus for example, if ten present inventions are connected to the analog pwm signal, if the analog pwm signal indicates that the linear optic systems within the present inventions should go to 50% light output, then all ten present inventions will go to 50% light output. Other configurations include using what is called an expansion module as disclosed in the '347 application which is located externally to the present invention and will take in the 0 to 10 Vdc control voltage and send out an analog pwm signal to one or multiple of the present invention to control dimming.

In the case where the dimming is controlled externally however each of linear housings needs to be controlled independently, a more advanced network may be used to achieve the addressable control. In this situation, the linear housings will require a control board to be installed within the housing of the linear optic system to offer advanced control of the system. In this situation, one or multiple linear housings will receive a unique address that can be programmed one of four ways. The first way is by using switches (such as dip switches) located within the housing or linear optic system that set the address. The second way is to assign the address to the control board upon programming the microcontroller at the factory. The third way is to assign the address to the present invention over the network. The fourth way is to assign the address to the present invention by connecting an external device to the microcontroller located within the housing and programming the present invention prior to placing it on the network. This external device can be in the form of a hand held unit, a laptop, a personal computer, etc. Once the addresses are assigned to the present invention, the present invention will connect to a variety of networks and protocols including RS-485 (including DMX512 protocol), RS-232, Ethernet, 802.11, Bluetooth, and any other type of network that may be controlled by any type of user interface including that of touch screen, membrane switch, keypad, keyboard, switch, mouse, or dimmer. The networks are described in application Ser. No. 11/101,643 filed Apr. 8, 2005, entitled “Marine LED Lighting Network and Driver”, incorporated by reference herein in its entirety and assigned to the instant assignee (hereinafter '643 application).

For many applications, whether it is a shipboard lighting system or an architectural lighting application, there is a requirement for emergency lighting. In the case of the present invention, the housing may be configured to accept a back up battery that will connect to the linear optic system or control board located within the housing and provide battery operation should the main voltage powering the present invention be removed, then the linear optic system shall resume operation using the battery as the source of power. The linear housing in this configuration will have a battery charger within it that is either a separate module or is located directly on the control board. The linear housing will also have a circuit that monitors the main voltage such that should it fail; there will be a seamless switch over to the battery power source. The type of battery back up may be one of a nickel metal hydride, lithium ion, lead acid, nickel cadmium, etc. For applications where there is a network connection present such as described above, the battery status may be reported back to the network. For example, if the battery charger reports that the battery charging has timed out indicating that the battery won't take charge and is therefore requiring service, the present invention will send out a report on the network stating that it requires attention. The present invention may also have an indicator device located such that if there is no network present or in addition to the network, the present invention will have a means of displaying that it requires service such as in the form of an LED indicator, audible signal, etc.

In some cases, the present invention will include within the housing both the linear optic system sources and a conventional source such as a fluorescent, halogen, incandescent, metal halide, or sodium light source thus constituting a hybrid system. In this case, it is advantageous in some applications to use the linear optic system as the preferred source of battery backup (as described above) and the conventional source as the means of illumination under typical conditions. This configuration is applicable in situations for example where the linear optic system is not bright enough for illuminating under typical conditions, however is bright enough for battery back up conditions, for example an emergency condition where the light output specification is less then the typical operating specification. The advantage the linear optic system offers over the conventional source is that as it is a directional and at times a more efficient source (depending on the conventional source the LED is compared to) the linear optic system will consume less power, thus the batteries will last longer. It is also advantageous to use the linear optic system as the source as since the linear optic system can be configured to take a DC input voltage, the size and complexity of the circuit required to connect the linear optic system to the battery will be minimal. On the other hand, a fluorescent will require a more complex inverter circuit, which reduces efficiency, adds cost, and adds size to the battery backup system.

Still other aspects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and several details are capable of modification in various obvious respects, all without departing from the invention. Accordingly, the drawings are to be regarded as illustrative in nature, and not as restrictive.

### DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 is a perspective view of the linear LED housing assembly without a window according to the present invention;

FIG. 2 is a partial perspective view of the linear LED housing assembly of FIG. 1;

FIG. 3 is a cross section taken along lines 3-3 in FIG. 1;

FIG. 4 is a partial perspective view of the power supply in the linear LED housing assembly along lines 4-4 in FIG. 1;

FIG. 5 is a partial perspective view of the control PCB in the linear LED housing assembly of FIG. 1;

FIG. 6 is a perspective view of a linear optic system;

FIG. 7 is a perspective view of linear LED housing assembly;

FIG. 8 is a bottom perspective view of the linear LED housing assembly;

FIG. 9 is a bottom perspective view of the linear housing assembly without a cover, including two linear optic systems, a battery pack and two reflectors, according to the present invention;

FIG. 10 is a partial perspective view of the battery and driver in the linear housing assembly of FIG. 9;

FIG. 11 is a perspective view of the control PCB in the linear LED housing assembly of FIG. 9; and

FIG. 12 is a perspective view of the linear housing assembly with a window having a diffused face.

### BRIEF DESCRIPTION OF THE INVENTION

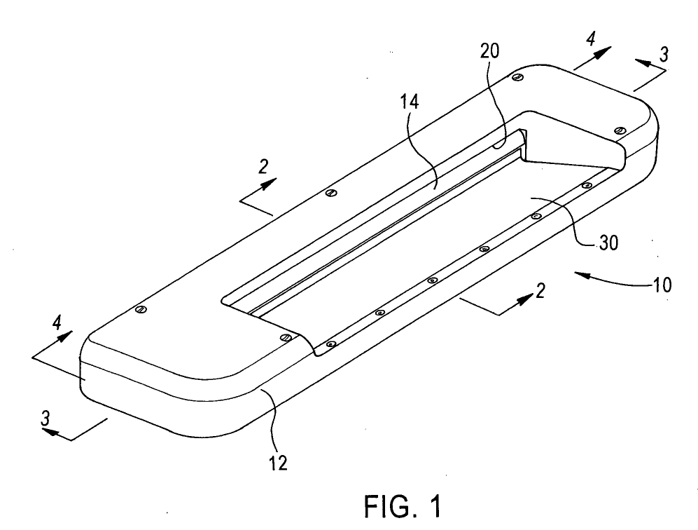

Refer first to FIG. 1 where a linear housing assembly 10 is illustrated. The linear housing assembly 10 includes a housing 12 and an LED light source or linear optic system 14. The light source 14 is a linear LED light source described in the '347 application number.

Light source 14 emits light through a slot 20 in the housing 12 which is subsequently reflected by a reflector 30. The housing 12 has a roughly rectangular shape.

The present invention includes the housing 12 that is used for illumination and utilizes the linear optic system 14 as a light source. While the linear optic system 14 works well for a variety of applications, there are many applications where a standalone linear optic system 14 does not lend itself well including applications where the light fixture is subjected to environmental considerations including: UV, heat, water, ice, shock, and vibration. The linear optic system 14 also does not lend itself well in applications where the physical characteristics of the light fixture are to be decorative as well as functional.

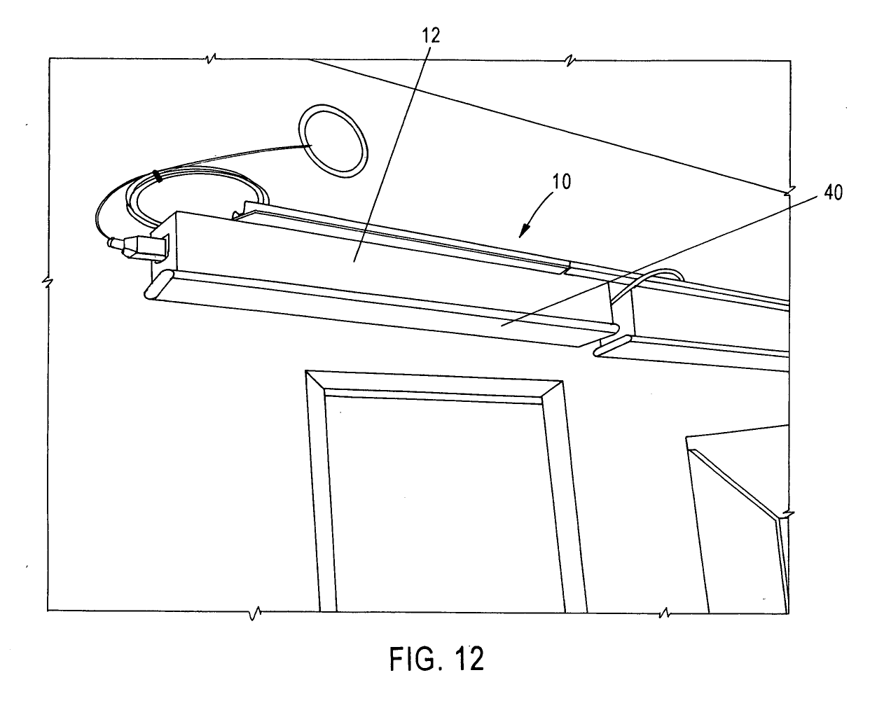

The present invention can be used for a variety of applications including those where fluorescent fixtures are traditionally used. The actual size of the housing 12 is customizable per application, in some cases the housing 12 being over eight (8) feet long, in other cases, the housing 12 being only several inches long. In both cases, the housing 12 utilizes the linear optic system 14 as a light source which is customized in length and configuration to fit the housing 12. The material of the housing 12 may be plastic or metal, metal including that of stainless steel, aluminum, brass, bronze, copper etc. Generally, housings 12 will be extruded due to the linear configuration of the linear optic system 14, however housings 12 may also be machined, molded, stamped, or cast. Due to its low profile, the linear optic system 14 allows the housing 12 size to be very low profile, however simultaneously, for applications where a larger housing is required; there is no limitation to the physical size of the fixture. Housings 12 may be decorative or plain, depending on the application. For an application where the present invention is used for general illumination in a hotel lobby, the housing 12 may be decorative, including fancy or contemporary lines, engravings, and features to be added to the housing. In the case that the present invention is used as a flush mounted illumination panel on a US Navy flight deck, such as those used as line up lights for incoming helicopters, the housing will be manufactured for high impact, high vibration, and demanding weather conditions. In this case, a smooth surface is preferred in order to reduce the radar cross section of the vessel. Therefore it should be noted that the actual housing used in the present invention is designed to accommodate one or more linear optic system 14 configurations and is completely customizable in, material, style, size, thickness, etc. (see, for example, FIG. 12).

While the housing 12 may be used only for decorative or functional purposes and may not require a protective window, depending on the application, the housing 12 may in fact require this level of protection. A protective window 40 (not shown in FIG. 1 but shown in FIG. 12) can be simply designed to keep dust out of the housing 12, or it can be more robustly designed to keep out water, chemicals, and provide a surface designed for high impact. The material of the window 40 can be that of glass, tempered glass, polycarbonate, acrylic, or any other clear material as required by the application. The material may be of any thickness depending on the application. The window 40 may be installed by traditional methods, including those of using a gasket and fasteners. The window 40 may also be installed such that it is adhered permanently to the housing 12. This is possible due to the long life of the linear optic system 14 source. Adhesives may include UV activated adhesives. The window 40 material may also range in light emitting characteristics. For example, the window may be frosted to provide a glowing surface. It may be optically clear and optically coated to allow light to pass through with minimum loss. It may be colored such that it will filter the light emitting from the linear optic system (i.e. a blue coloring on the window will only allow blue light to pass through). It may be coated with antiglare materials to reduce glare coming off of the fixture, etc. For additional effect and control, between the window and the linear optic system 14, filters and diffusers may be incorporated into the housing as shown in FIG. 12. Diffusers include holographic diffusers that are designed to change the emitting angle of the linear optic system 14. Color filters include those used conventionally such as those manufactured by Rosco International (www.rosco.com). Filters may be used not only for effect, but for color correction. While white LED technology has steadily progressed, most available white LEDs are available between 5500 and 10,000 Kelvin, which ranges from a very white light (5500 K) to a bluish white light (10,000 K). While this is acceptable for many applications, many architectural applications will require a warmer white, such at 2,800 Kelvin, which is that of a traditional incandescent bulb. For example, while the linear optic system 14 may have a color temperature of 6000 Kelvin, by inserting the proper color filter between the linear optic system 14 and the window 40, the color temperature emitted from the housing 12 will be that of 2,800 Kelvin. The color filters (gels) may be installed mechanically such as that of a bracket, or installed by a tape or adhesive to the window 40, housing 12, or linear optic system 14. The diffusers and filters may be installed at the factory or sold to the end user for installation in the field, thus offering greater flexibility to the installer. It also should be noted that should a color that is available in an LED package be specified for a program such as the color Red, then no filter will be required as the LED source is a monochromatic source and will not require a filter to generate the red color. In addition, should the present invention be required to produce multiple colors of light from a single fixture, there are two ways to do so. The first way is to use two different color LEDs in a single linear optic system 14 or multiple linear optic systems 14, such as white and red or any other combination of colors and switch back and forth depending on what effect is desired. This offers advantages never before possible with fluorescent lighting as the fluorescent fixture would need to accommodate two fluorescent bulbs, one that is white and one that is white with a red filter or a colored fluorescent, resulting in a much larger fixture size. The second way is to use color mixing. By installing into the linear optic system 14 or into multiple linear optic systems 14, three LED colors, red, green, and blue, the present invention will be capable of generating millions of different colors and effects by creating combinations of the three colors.

While the linear optic system 14 utilizes its own optical configuration, reflective surfaces and reflectors 30 may be used internal and/or external to the housing 12 to offer additional control of the light emitted.

The linear optic system 14 can be installed to the housing 12 a number of ways depending on the application and the function. The linear optic system 14 can be installed via an adhesive, including thermally conductive adhesive, by fasteners, by press fit or other type of mechanical fit. Depending on the application, the linear optic system 14 may be installed with either permanent or adjustable mounting. For applications where the light fixture is intended for a single purpose, such as a Navy Bunk Light, the housing may be designed and the linear optic system 14 positioned at the factory such that the present invention provides the proper light distribution and effect. For generic usage, the housing 12 may be designed such that the linear optic system 14 is installed on an assembly that is capable of pivoting, thus allowing the installer to move the linear optic system 14 within the fixture in order to achieve the proper effect. The pivoting may occur via a friction fit, by pivoting the linear optic system 14 and tightening down on a fastener in order to lock the pivot in place or by any other means that a pivot may be accomplished. The linear optic system 14 may also be positioned such that the distance between the linear optic system 14 and the window 40 or top of the housing 12 may be adjusted in order to allow flexibility to the design. Generic usage is critical for applications such as architectural lighting where as a lighting specifier will use the same light fixture for multiple applications, thus requiring flexibility in order to achieve the proper effect. Recognize that the multiple linear optic systems 14 may be used within a single housing and that they may pivot independently. For example, if the present invention is used for illuminating the exterior wall of a building that includes a window, the two linear optic systems 14 may be installed into the housing 12. The first linear optic system 14 will be directed below the window 40. The second linear optic system 14 will be directed above the window 40. Therefore, there is a wash on the building wall while there is no glare on the building window. It should be noted that the unlike any other linear light fixture, the present invention is capable of millions of light distribution patterns and emitting angles due to the fact that the linear optic system 14 may be adjusted within the fixture to produce any effect required for an application. Typically light fixtures are purchased with a specific emitting angle. The present invention may be purchased as a generic system that is capable of many emitting angle configurations. While providing environmental protection to the linear optic system 14, the housing 14 also functions as a heat sink for the linear optic system 14 allowing the linear optic system 14 to take advantage of the extra surface area provided by the housing. In some cases, it is required that when the linear optic system 14 is installed, it should be installed with a thermal grease, thermal tape, or thermal epoxy. Fans may also be installed within the housing 12 in order to provide air circulation within the fixture 10 to minimize thermal hot spots or to replace the air in the housing depending on the configuration.

As a fluorescent fixture has a ballast to power the bulb, LED systems require a constant current source, whether it is a power resistor or a semiconductor based design such as an I2S SmartDriver (high efficiency switching regulator) disclosed in the '347 application. This constant current source, many times referred to as a driver 120 may be located in one of three places. The first location as described in the '347 application is within the linear optic system 14. In this configuration disclosed the '347 application, wires or a multi-conductor cable will enter the housing 12 of the present invention and wire to the one or more linear optic system 14 assemblies located within the housing. Wires may enter through a strain relief that may be waterproof. Electrical connection my also be made via an electrical connector located on the housing which is wired to the linear optic system 14. The connectors may be positioned and designed such that either a cable assembly will mate with the connector 400 on the housing, or one housing may plug into another housing, thus eliminating wiring between fixtures for applications where more than one fixture is utilized. The second location that the driver may be located is within the housing, where as one or multiple drivers and associated wiring and controls will be mounted within the housing and electrically connected same as above. The third location that the driver may be located is external to the housing and wired to one or more of the present inventions same as above. For all three configurations, the input voltage may vary from application to application, some being that of line voltage (i.e. 120, 220, 270 VAC) and some being of low voltage (i.e. 12, 24 VAC). In some cases, a power supply 50 or transformer may be installed to the housing and wired in line between the incoming voltage and the driver to step down/boost and clean up the input voltage.

The driver systems also are capable of 0 to 100% dimming which never before has been possible in a fluorescent system. The dimming may be controlled either locally at the present invention or remotely. In most cases of dimming, an additional control board or control assembly will be installed within the housing or the linear optic system 14.

In the case where dimming is controlled locally at the present invention, this is typically for applications where the present invention will be installed, the light level of the linear optic system 14 will be set at the fixture for the optimal level for the application, and the intensity of the linear optic system 14 will most likely not be adjusted in the future. The electronics for doing so will be installed within the housing. The linear optic system 14 intensity may be adjusted by but not limited to a potentiometer or by a hand held programming device that connects to the electronics within the housing. It is also a known fact that for any light source including LEDs, that over time the source will decrease in light output, which is called lumen maintenance. Therefore, a solution to avoid lower light levels over time is to set the present invention's intensity at the preferred level once installed and then through the use of a controller located within the housing or within the linear optic system 14, program the fixture such that over time the driver's output current will slowly increase to make up for the reduced efficiency of the LEDs.

In the case where the dimming is controlled externally to the present invention, there are several ways to do so. The first way is by connecting to the present invention a standard 0 to 10 Vdc control voltage. The 0 to 10 Vdc control voltage is typically used in architectural applications whereas the control voltage is used as a reference voltage. The second way to control the intensity is by connecting to the present invention an analog pwm signal that is used to provide a reference. This method is preferred to the 0 to 10 Vdc control voltage as it can be used over much longer distances. In both cases, if multiple linear housings are connected to the same control voltage or analog pwm signal, each will respond identically, thus for example, if 10 present inventions are connected to the analog pwm signal, if the analog pwm signal indicates that the linear optic systems 14 within the present inventions should go to 50% light output, then all 10 present inventions will go to 50% light output. Other configurations include using what is called an expansion module as disclosed in the '347 application which is located externally to the present invention and will take in the 0 to 10 Vdc control voltage and send out an analog pwm signal to one or multiple of the present invention to control dimming. In the case where the dimming is controlled externally however each of linear housings 12 needs to be controlled independently, a more advanced network may be used to achieve the addressable control. In this situation, the linear housings 12 will require a control board to be installed within the housing of the linear optic system 14 to offer advanced control of the system. In this situation, one or multiple linear housings 12 will receive a unique address that can be programmed one of four ways. The first way is by using switches (such as dip switches) located within the housing or linear optic system 14 that set the address. The second way is to assign the address to the control board 200 (see FIG. 11) upon programming the microcontroller at the factory. The third way is to assign the address to the present invention over the network. The fourth way is to assign the address to the present invention by connecting an external device to the microcontroller 202 located within the housing and programming the present invention prior to placing it on the network. This external device can be in the form of a hand held unit, a laptop, a personal computer, etc. Once the addresses are assigned to the present invention, the present invention will connect to a variety of networks and protocols including RS-485 (including DMX512 protocol), RS-232, Ethernet, 802.11 Wireless, Bluetooth. For example, the networks are disclosed in the '643 application. All of the network principles discussed in the '347 application are applicable here. Therefore, the present invention may be controlled via many types of network connections and many types of user interfaces, etc.

For many applications, whether it is a shipboard lighting system or an architectural lighting application, there is a requirement for emergency lighting. In the case of the present invention, the housing may be configured to accept a back up battery pack 80 that will connect to the linear optic system 14 or control board 200 located within the housing and provide battery operation should the main voltage powering the present invention is removed, then the linear optic system 14 shall resume operation using the battery as the source of power. The linear housing 14 in this configuration will have a battery charger within it that is either a separate module or is located directly on the control board. The linear housing 12 will also have a circuit that monitors the main voltage such that should it fail; there will be a seamless switch over to the battery power source. The type of battery back up may be one of a nickel metal hydride, lithium ion, lead acid, nickel cadmium, etc. For applications where there is a network connection present such as described above, the battery pack 80 status may be reported back to the network. For example, if the battery charger reports that the battery charging has timed out indicating that the battery pack 80 will not take a charge and is therefore requiring service, the present invention will send out a report on the network stating that it requires attention. The present invention may also have an indicator device located such that if there is no network present or in addition to the network, the present invention will have a means of displaying that it requires service such as in the form of an LED indicator, audible signal, etc.

In some cases, the present invention will contain within the housing 12 both the linear optic system 14 sources and a conventional source such as a fluorescent, halogen, incandescent, metal halide, or sodium light source thus constituting a hybrid system. In this case, it is advantageous in some applications to use the linear optic system 14 as the preferred source of battery backup (as described above) and the conventional source as the means of illumination under typical conditions. This configuration is applicable in situations for example where the linear optic system 14 is not bright enough for illuminating under typical conditions, however is bright enough for battery back up conditions, for example an emergency condition where the light output specification is less then the typical operating specification. The advantage the linear optic system 14 offers over the conventional source is that as it is a directional and at times a more efficient source (depending on the conventional source the LED is compared to) thus the linear optic system 14 will consume less power, thus the batteries will last longer. It is also advantageous to use the linear optic system 14 as the source as since the linear optic system 14 can be configured to take a DC input voltage, the size and complexity of the circuit required to connect the linear optic system 14 to the battery will be minimal. On the other hand, a fluorescent will require a more complex inverter circuit, which reduces efficiency, adds cost, and adds size to the battery backup system.

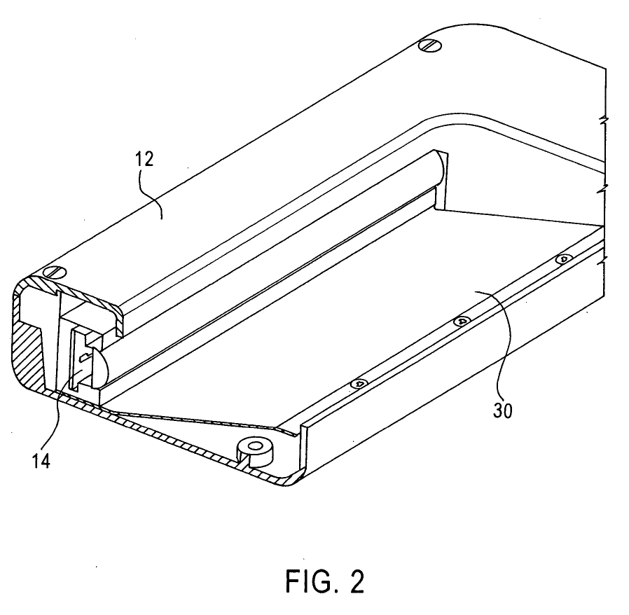

Referring now to FIG. 2, the linear optic system 14 is illustrated in cross section.

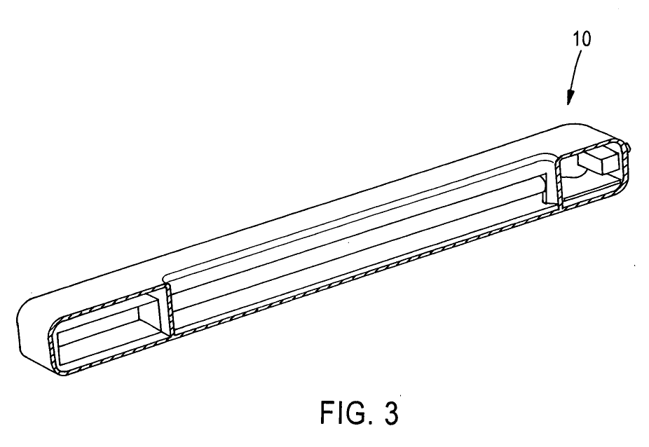

Referring now to FIG. 3, a cross section of the housing 12 is illustrated.

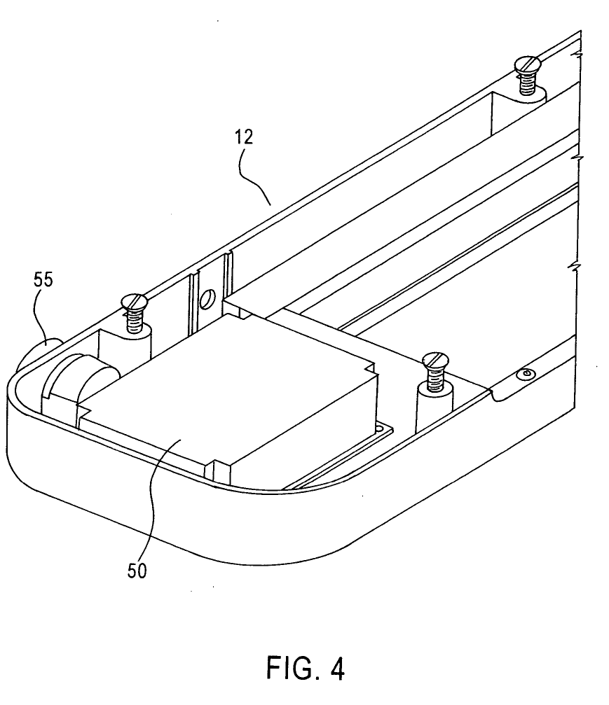

Referring now to FIG. 4, a power supply 50 is illustrated within the housing 12. A wire relief 55 provides an input path for power to the power supply.

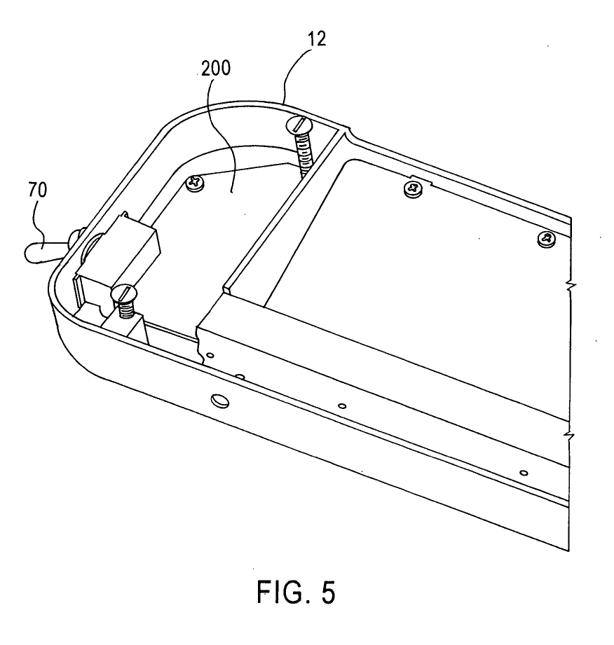

Referring now to FIG. 5, a switch 70 controls power to the linear optic system 14.

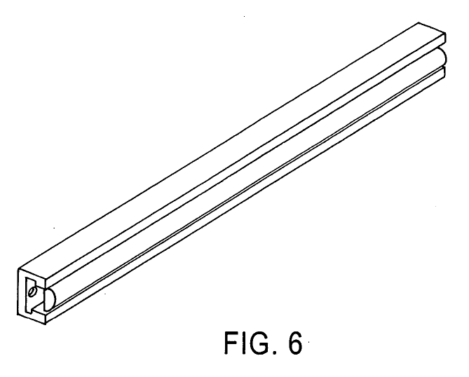

FIG. 6 is a perspective view of the linear optic system 14.

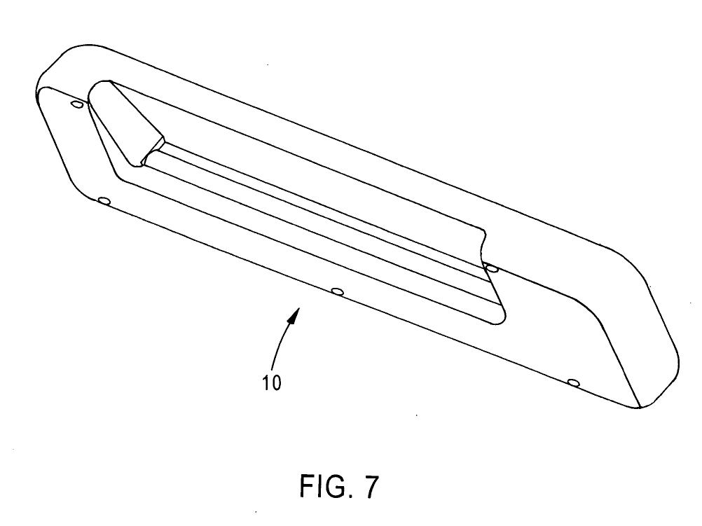

FIG. 7 is a perspective view of the linear housing assembly 10.

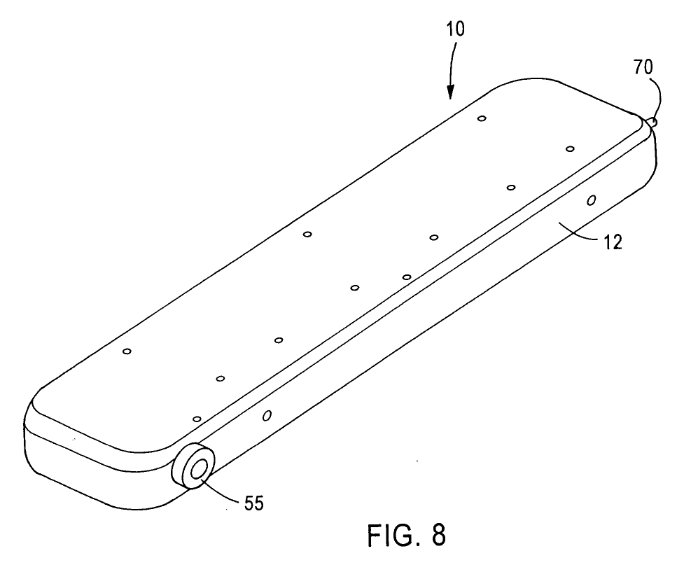

FIG. 8 is a bottom view of the linear housing assembly 10.

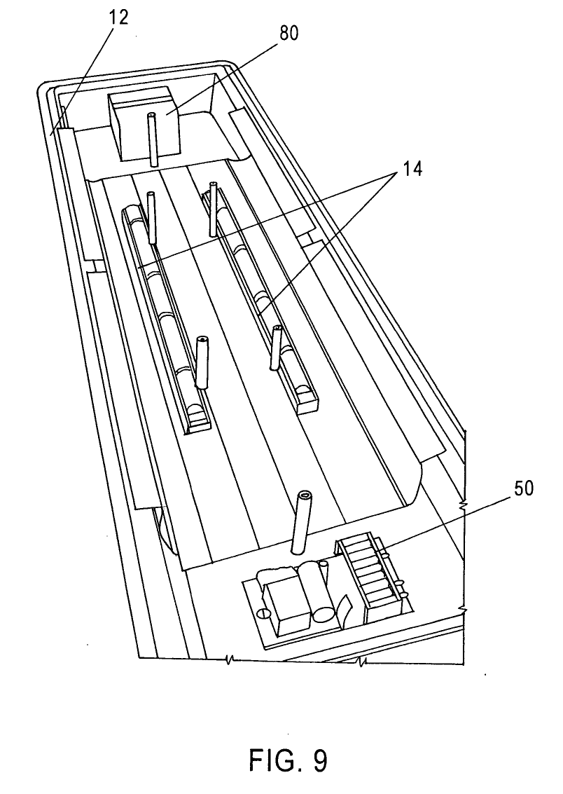

FIG. 9 is an illustration of another embodiment of the present invention using two linear based linear optic systems 14.

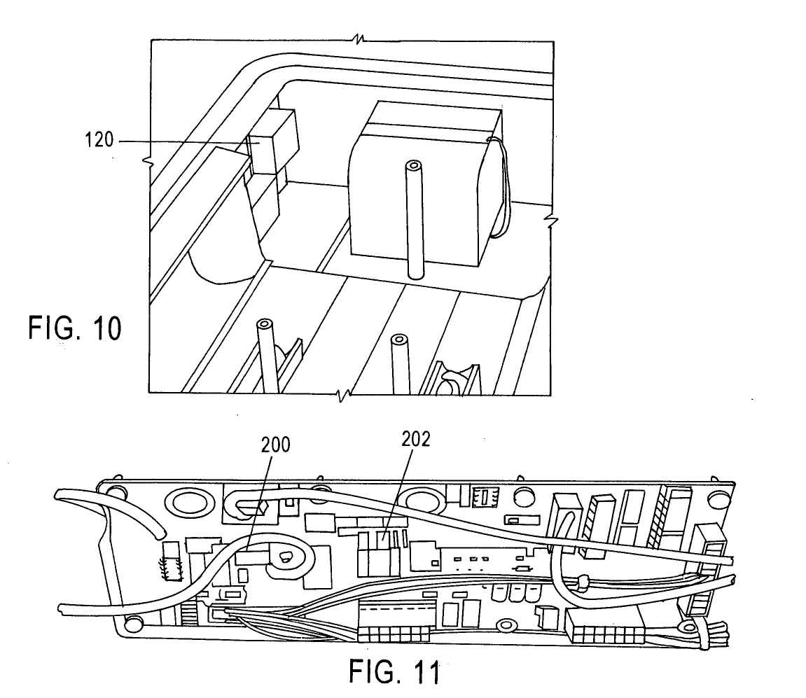

FIG. 10 illustrates two drivers 120.

FIG. 11 illustrates a circuit board 200 having a microcontroller 202.

FIG. 12 illustrates a housing 12 having a diffuser as a window 40.

It should now be apparent that a linear housing assembly has been described which provides all of the advantages discussed above.

It will be readily seen by one of ordinary skill in the art that embodiments according to the present invention fulfill many of the advantages set forth above. After reading the foregoing specification, one of ordinary skill will be able to affect various changes, substitutions of equivalents and various other aspects of the invention as broadly disclosed herein. It is therefore intended that the protection granted hereon be limited only by the definition contained in the appended claims and equivalents thereof.

1. An LED housing assembly, comprising:
a housing; and
an LED linear optic system within said housing.
